(19) United States
(12) Patent Application Publication
(10) Pub. No.: US 2022/0414372 A1
(43) Pub. Date: Dec. 29, 2022

(54) SCENE DETECTION METHOD AND APPARATUS, ELECTRONIC DEVICE AND COMPUTER STORAGE MEDIUM

(71) Applicant: SENSETIME INTERNATIONAL PTE. LTD, Singapore (SG)

(72) Inventors: Jiacheng WU, Singapore (SG); Shual Zhang, Singapore (SG); Jiriliang Lin, Singapore (SG); Xin Gan, Singapore (SG)

(21) Appl. No.: 17/363,191

(22) Filed: Jun. 30, 2021

Related U.S. Application Data
(63) Continuation of application No. PCT/IB2021/055737, filed on Jun. 28, 2021.

(30) Foreign Application Priority Data
Jun. 25, 2021 (SG) 10202107011W

(51) Int. Cl. G06K 9/00

(52) U.S. Cl. CPC G06K 9/00624; H04L 67/10

(57) ABSTRACT

Provided are a scene detection method and apparatus, an electronic device and a computer storage medium. The method includes: own device running data and scene information collected by a collection device are acquired through an own first detection system component; the device running data and the scene information are made pulled to a cloud for the cloud to detect itself and the collection device; in a case of a detection exception of the cloud, an own first device state is detected according to the device running data, and a second device state of the collection device is detected based on the scene information; and in a case where both the first device state and the second device state are normal, a scene state is detected according to a present frame of scene image in the scene information and a locally stored configuration file to obtain a detection result for use.

### CROSS-REFERENCE TO RELATED APPLICATION

This is continuation application of international application PCT/IB2021/055737, filed on 28 Jun. 2021, which claims priority to Singaporean patent application No. 10202107011W, filed with IPOS on 25 Jun. 2021. The contents of international application PCT/IB2021/055737 and Singaporean patent application No. 10202107011W are incorporated herein by reference in their entireties.

### TECHNICAL FIELD

The disclosure relates to an intelligent detection technology, and particularly to a scene detection method and apparatus, an electronic device and a computer storage medium.

### BACKGROUND

With the rapid development of computer technologies, intelligent detection of target scenes has attracted more and more attentions and been used extensively. Particularly when a target scene is implemented, it is important to detect implementation of the target scene in real time.

In the related art, the detection on an implementation situation of a target scene has low flexibility and low detection effect.

### SUMMARY

Embodiments of the disclosure provide a scene detection method and apparatus, an electronic device and a computer storage medium, which may improve the detection flexibility and detection effect of implementation situations of some specific scenes.

The technical solutions of the embodiments of the disclosure are implemented as follows.

The embodiments of the disclosure provide a scene detection method, which may be applied to an edge device and include the following operations.

Own device running data and scene information collected by a collection device are acquired through an own first detection system component. The device running data and the scene information are made pulled to a cloud for the cloud to detect itself and the collection device. In a case of a detection exception of the cloud, an own first device state is detected according to the device running data, and a second device state of the collection device is detected based on the scene information. In a case where both the first device state and the second device state are normal, a scene state is detected according to a present frame of scene image in the scene information and a locally stored configuration file to obtain a detection result, the detection result being used for another business.

In the embodiments of the disclosure, since the edge device and the cloud may detect the edge device and the collection device respectively, a failure of a cloud device may not affect detection of the edge device and the collection device by the edge device. In a case where the states of the edge device and the collection device are normal, the edge device may further detect the scene state according to the present scene image collected by the collection device and the locally stored related configuration file to obtain the detection result that may be used for the other business, so that implementation situations of some specific scenes (for example, a table game) may be detected conveniently, normal implementation of the scenes is facilitated, and the detection flexibility and detection effect are further improved.

In some embodiments, the operation that, in the case of the detection exception of the cloud, the own first device state is detected according to the device running data and the second device state of the collection device is detected based on the scene information may include that: in the case of the detection exception of the cloud, the own first device state is detected in real time according to the device running data and a first local alerting rule stored in itself; and the second device state of the collection device is detected in real time according to the scene information and a second local alerting rule stored in itself, the first local alerting rule being at least partially the same as a first cloud alerting rule stored in the cloud, and the second local alerting rule being at least partially the same as a second cloud alerting rule stored in the cloud.

In the embodiments of the disclosure, the edge device may detect the device states of the edge device and the collection device using different alerting rules respectively, and the alerting rules stored in the edge device are at least partially the same as the alerting rules stored in the cloud, so that the diversity of detecting the edge device and the collection device may be achieved.

In some embodiments, the method may further include that: in a case where the first device state is abnormal, and/or the second device state is abnormal, an alert is given using an own alerting part through an own first alerting component, and/or alert information is sent to a first target device through the first alerting component, the first target device being service device related to a scene.

In the embodiments of the disclosure, the edge device, when finding an exception of the edge device and/or the collection device, may send prompting information through its own indicator lamp, loudspeaker and other parts, or, may send the alert information to the service device related to the scene to implement upward feedback of the alert information, to enable a related person to timely know the exception, so that the intelligence is improved.

In some embodiments, the situation where the first device state is normal may include at least one of: a utilization rate of a processor is less than or equal to a preset utilization rate value, a time consumption for data processing is less than or equal to a preset time consumption threshold, or a frequency of acquiring the device running data is less than or equal to a preset frequency threshold.

In the embodiments of the disclosure, the edge device may determine by comparison a magnitude relationship between any parameter in the utilization rate of its own processor, its own time consumption for data processing and its own frequency of acquiring the device running data and the corresponding threshold to determine whether the edge device is in an abnormal state accurately, thereby implementing accurate detection of the device state of the edge device.

In some embodiments, the situation where the second device state is normal may include at least one of: the present frame of scene image exists in the scene information, or a region corresponding to the present frame of scene image is a preset collection region.

In the embodiments of the disclosure, the edge device may judge whether the present frame of scene image exists in the scene information or judge whether the region corresponding to the present frame of scene image is the preset collection region to obtain the device state of the collection device accurately, thereby implementing accurate detection of the device state of the collection device.

In some embodiments, the operation that the device running data and the scene information are made pulled to the cloud for the cloud to detect itself and the collection device may include that: the device running data and the scene information are made pulled to the cloud using a federation manner of the first detection system component through an own gateway component for the cloud to detect itself and the collection device.

In the embodiments of the disclosure, the edge device implements data transmission with the cloud through its own gateway component and the federation manner, so that the timeliness of data transmission may be improved, and the cloud may detect the device states of the edge device and the collection device conveniently.

In some embodiments, the method may further include that: in a case where the first detection system component is run, registration information including an own device identifier is sent to the cloud for the cloud to determine itself as an object to be detected according to the registration information.

In the embodiments of the disclosure, the edge device is registered with the cloud in a case where its own first detection system component is enabled, and then the cloud may detect the edge device timely, so that the timeliness of detecting the edge device and the collection device by the cloud is improved.

In some embodiments, the method may further include that: in a case where the cloud returns to normal, the device running data and the scene information are made pulled to the cloud for the cloud to detect itself and the collection device.

In the embodiments of the disclosure, the edge device sends its own running data and the scene information sent by the collection device to the cloud in a case where the cloud returns to normal, and then the cloud may continue to detect the edge device and the collection device, so that switching from detection by the edge device to detection by the cloud is implemented.

In some embodiments, the method may further include that: in a case of an own failure, the device running data and the scene information are stopped to be made pulled to the cloud to stop the cloud from detecting itself and the collection device.

In the embodiments of the disclosure, the edge device interrupts data transmission with the cloud in a case of an own failure, so that the cloud may judge whether data transmission with the edge device is normal to detect the edge device to timely know the exception of the edge device.

The embodiments of the disclosure provide a scene detection method, which may be applied to a cloud and include the following operations.

Device running data of an edge device to be detected and scene information collected by a collection device are pulled from the edge device through an own second detection system component. A first device state of the edge device is detected according to the device running data, and a second device state of the collection device is detected according to the scene information. In a case where both the first device state and the second device state are normal, a scene state is detected according to a present frame of scene image in the scene information and a stored configuration file to obtain a detection result, the detection result being used for another business.

In the embodiments of the disclosure, since the cloud detects the device states of the edge device and the collection device according to the device running data of the edge device and the scene information collected by the collection device respectively, and in a case where the states of the edge device and the collection device are normal, may detect the scene state according to the present scene image collected by the collection device and the locally stored related configuration file to obtain the detection result that may be used for the other business, so that an implementation situation of a specific scene (for example, a table game) may be detected conveniently, normal implementation of the scene is facilitated, and the detection flexibility and detection effect are further improved.

In some embodiments, the operation that the first device state of the edge device is detected according to the device running data and the second device state of the collection device is detected according to the scene information may include that: the first device state of the edge device is detected in real time according to the device running data and a first cloud alerting rule stored in itself; and the second device state of the collection device is detected in real time according to the scene information and a second cloud alerting rule stored in itself, the first cloud alerting rule being at least partially the same as a first local alerting rule stored in the edge device, and the second cloud alerting rule being at least partially the same as a second local alerting rule stored in the edge device.

In the embodiments of the disclosure, the cloud may detect the device states of the edge device and the collection device using different alerting rules respectively, and the alerting rules stored in the cloud are at least partially the same as the alerting rules stored in the edge device, so that the diversity of detecting the edge device and the collection device may be achieved.

In some embodiments, the method may further include that: in a case where the first device state is abnormal, and/or the second device state is abnormal, alert information is sent to a second target device through an own second alerting component, the second target device including a service device related to a scene and an Email server.

In the embodiments of the disclosure, in a case where an exception occurs to the edge device and/or the collection device, the cloud may send the alert information to the service device related to the scene and the Email server to implement upward feedback of the alert information to enable a related person to timely know the exception.

In some embodiments, the method may further include that: through an own service discovery component, registration information including a device identifier of an edge device is received from the edge device in real time, and a device identifier of an edge device that stops running a first detection system component is determined in real time; and an updated device list is obtained based on the device identifiers through the second detection system component by adding the device identifier of the edge device that sends the registration information to a device list and deleting the device identifier of the edge device that stops running the first detection system component from the device list, and the edge device corresponding to the device identifier in the updated device list is determined as the edge device to be detected.

In the embodiments of the disclosure, through the service discovery component and the second detection system component, the cloud may timely determine the edge device that is required to be detected and stop detecting the edge device that is not required to be detected, so that a utilization rate of a detection resource of the cloud and the timeliness of detecting the edge device and the collection device by the cloud are improved.

In some embodiments, the operation that the device running data of the edge device to be detected and the scene information collected by the collection device are pulled from the edge device through the second detection system component may include that: the device running data of the edge device to be detected and the scene information collected by the collection device are pulled from the edge device using a federation manner of the second detection system component through an own gateway component.

In the embodiments of the disclosure, the cloud implements data transmission with the edge device through its own gateway component and the federation manner, so that the timeliness of data transmission may be improved, and the device states of the edge device and the collection device may be detected conveniently.

In some embodiments, the method may further include that: the pulled device running data and scene information, and the updated device list are stored in a first database corresponding to itself; and a storage operation on the first database is recorded in a log file associated with the first database, and the log file is updated.

In the embodiments of the disclosure, the cloud stores all received and obtained data in the first database, records the storage operation on the first database in the log file, and updates the log file, so that data backup may be implemented, and the other device may implement data synchronization conveniently according to the log file.

The embodiments of the disclosure provide a scene detection method, which may be applied to a second cloud and include the following operations.

Based on an operation recorded in a log file acquired from a first cloud, the same operation is performed on a second database corresponding to itself to make data in the second database consistent with data in a first database corresponding to the first cloud. In a case where the first cloud is abnormal, device running data of an edge device to be detected and scene information collected by a collection device are pulled from the edge device through an own third detection system component. A first device state of the edge device is detected according to the device running data, and a second device state of the collection device is detected according to the scene information. In a case where both the first device state and the second device state are normal, a scene state is detected according to a present frame of scene image in the scene information and a stored configuration file to obtain a detection result, the detection result being used for another business.

In the embodiments of the disclosure, the second cloud may perform the same operation on the second database according to the operation recorded in the log file acquired from the first cloud to make consistent the data in the second database corresponding to the second cloud and the first database corresponding to the first cloud. When the first cloud fails, the second cloud continues to detect the edge device and the collection device, so that influences on detection of the edge device and the collection device are eliminated. In a case where the states of the edge device and the collection device are normal, the second cloud may further detect the scene state according to the present scene image collected by the collection device and the locally stored related configuration file to obtain the detection result that may be used for the other business, so that an implementation situation of a scene such as an intelligent table game may be detected conveniently, normal implementation of the scene is facilitated, and the detection flexibility and detection effect are further improved.

The embodiments of the disclosure provide a first scene detection apparatus, which may be implemented on an edge device and include a first detection system component, a first alerting component and a first identification component.

The first detection system component may be configured to acquire own device running data and scene information collected by a collection device, and have the device running data and the scene information pulled to a cloud for the cloud to detect itself and the collection device.

The first alerting component may be configured to, in a case of a detection exception of the cloud, detect an own first device state according to the device running data, and detect a second device state of the collection device based on the scene information.

The first identification component may be configured to, in a case where both the first device state and the second device state are normal, detect a scene state according to a present frame of scene image in the scene information and a locally stored configuration file to obtain a detection result, the detection result being used for another business.

In some embodiments, the first alerting component is further configured to, in the case of the detection exception of the cloud, detect the own first device state in real time according to the device running data and a first local alerting rule stored in itself, and detect the second device state of the collection device in real time according to the scene information and a second local alerting rule stored in itself, the first local alerting rule being at least partially the same as a first cloud alerting rule stored in the cloud, and the second local alerting rule being at least partially the same as a second cloud alerting rule stored in the cloud.

In some embodiments, an alerting part is further included. The first alerting component is further configured to, in a case where the first device state is abnormal, and/or the second device state is abnormal, give an alert using the alerting part through the first alerting component, and/or send alert information to a first target device through the first alerting component, the first target device being service device related to a scene.

In some embodiments, the situation where the first device state is normal includes at least one of: a utilization rate of a processor is less than or equal to a preset utilization rate value, a time consumption for data processing is less than or equal to a preset time consumption threshold, or a frequency of acquiring the device running data is less than or equal to a preset frequency threshold.

In some embodiments, the situation where the second device state is normal includes at least one of: the present frame of scene image exists in the scene information, or a region corresponding to the present frame of scene image is a preset collection region.

In some embodiments, a gateway component is further included. The first detection system component is further configured to make the device running data and the scene information pulled to the cloud using a federation manner of the first detection system component through the gateway component for the cloud to detect itself and the collection device.

In some embodiments, the first detection system component is further configured to, in a case where the first detection system component is run, send registration information including an own device identifier to the cloud for the cloud to determine itself as an object to be detected according to the registration information.

In some embodiments, the first detection system component is further configured to, in a case where the cloud returns to normal, make the device running data and the scene information pulled to the cloud for the cloud to detect itself and the collection device.

In some embodiments, the first detection system component is further configured to, in a case of an own failure, stop making the device running data and the scene information pulled to the cloud to stop the cloud from detecting itself and the collection device.

The embodiments of the disclosure provide a second scene detection apparatus, which may be implemented on a cloud and include a second detection system component, a second alerting component and a second identification component.

The second detection system component may be configured to pull device running data of an edge device to be detected and scene information collected by a collection device from the edge device.

The second alerting component may be configured to detect a first device state of the edge device according to the device running data, and detect a second device state of the collection device according to the scene information.

The second identification component may be configured to, in a case where both the first device state and the second device state are normal, detect a scene state according to a present frame of scene image in the scene information and a stored configuration file to obtain a detection result, the detection result being used for another business.

In some embodiments, the second alerting component is further configured to detect the first device state of the edge device in real time according to the device running data and a first cloud alerting rule stored in itself, and detect the second device state of the collection device in real time according to the scene information and a second cloud alerting rule stored in itself, the first cloud alerting rule being at least partially the same as a first local alerting rule stored in the edge device, and the second cloud alerting rule being at least partially the same as a second local alerting rule stored in the edge device.

In some embodiments, the second alerting component is further configured to, in a case where the first device state is abnormal, and/or the second device state is abnormal, send alert information to a second target device through the second alerting component, the second target device including a service device related to a scene and an Email server.

In some embodiments, a service discovery component is included, which is configured to receive registration information including a device identifier of an edge device from the edge device in real time, and determine a device identifier of an edge device that stops running a first detection system component in real time. The second detection system component is further configured to obtain an updated device list based on the device identifiers through the second detection system component by adding the device identifier of the edge device that sends the registration information to a device list and deleting the device identifier of the edge device that stops running the first detection system component from the device list, and determine the edge device corresponding to the device identifier in the updated device list as the edge device to be detected.

In some embodiments, a gateway component is further included. The second detection system component is further configured to pull the device running data of the edge device to be detected and the scene information collected by the collection device from the edge device using a federation manner of the second detection system component through the gateway component.

In some embodiments, the first cloud has a corresponding first database, and the first database is associated with a log file. The first cloud further includes a storage component, configured to store the pulled device running data and scene information and the updated device list in the first database, record a storage operation on the first database in the log file, and update the log file.

The embodiments of the disclosure provide a third scene detection apparatus, which may be implemented on a second cloud and include a data synchronization component, a third detection system component, a third alerting component and a third identification component.

The data synchronization component may be configured to, based on an operation recorded in a log file acquired from a first cloud, perform a same operation on a second database to make data in the second database consistent with data in a first database corresponding to the first cloud.

The third detection system component may be configured to, in a case where the first cloud is abnormal, pull device running data of an edge device to be detected and scene information collected by a collection device from the edge device.

The third alerting component may be configured to detect a first device state of the edge device according to the device running data, and detect a second device state of the collection device according to the scene information.

The third identification component may be configured to, in a case where both the first device state and the second device state are normal, detect a scene state according to a present frame of scene image in the scene information and a stored configuration file to obtain a detection result, the detection result being used for another business.

The embodiments of the disclosure provide an electronic device, which may include a memory and a processor.

The memory may be configured to store an executable computer program.

The processor may be configured to execute the executable computer program stored in the memory to implement the scene detection method described above.

The embodiments of the disclosure provide a computer-readable storage medium, which may store a computer program, configured to be executed by a processor to implement the scene detection method described above.

### BRIEF DESCRIPTION OF THE DRAWINGS

FIG. 1 is an optional structure diagram of a scene detection system according to an embodiment of the disclosure.

FIG. 2 is an optional flowchart of a scene detection method according to an embodiment of the disclosure.

FIG. 3 is an optional flowchart of a scene detection method according to an embodiment of the disclosure.

FIG. 4 is an optional flowchart of a scene detection method according to an embodiment of the disclosure.

FIG. 5 is an optional flowchart of a scene detection method according to an embodiment of the disclosure.

FIG. 6 is an optional flowchart of a scene detection method according to an embodiment of the disclosure.

FIG. 7 is an optional flowchart of a scene detection method according to an embodiment of the disclosure.

FIG. 8 is an optional flowchart of a scene detection method according to an embodiment of the disclosure.

FIG. 9 is an optional flowchart of a scene detection method according to an embodiment of the disclosure.

FIG. 10 shows an example of an interaction process between an edge device and an intelligent game table and between the edge device and a first cloud or a second cloud as well as structure diagrams of the edge device and the first cloud or the second cloud according to an embodiment of the disclosure.

FIG. 11 is a structure composition diagram of a first scene detection apparatus according to an embodiment of the disclosure.

FIG. 12 is a structure composition diagram of a second scene detection apparatus according to an embodiment of the disclosure.

FIG. 13 is a structure composition diagram of a third scene detection apparatus according to an embodiment of the disclosure.

FIG. 14 is a first structure composition diagram of an electronic device according to an embodiment of the disclosure.

FIG. 15 is a second structure composition diagram of an electronic device according to an embodiment of the disclosure.

FIG. 16 is a third structure composition diagram of an electronic device according to an embodiment of the disclosure.

### DETAILED DESCRIPTION

For making the objectives, technical solutions and advantages of the disclosure clearer, the disclosure will further be described below in combination with the drawings in detail. The described embodiments should not be considered as limits to the disclosure. All other embodiments obtained by those of ordinary skill in the art without creative work shall fall within the scope of protection of the disclosure.

“Some embodiments” involved in the following descriptions describes a subset of all possible embodiments. However, it can be understood that “some embodiments” may be the same subset or different subsets of all the possible embodiments, and may be combined without conflicts.

Term “first/second/third” involved in the following descriptions is only for distinguishing similar objects and does not represent a specific sequence of the objects. It can be understood that “first/second/third” may be interchanged to specific sequences or orders if allowed to implement the embodiments of the disclosure described herein in sequences except the illustrated or described ones.

Unless otherwise defined, all technological and scientific terms used in the disclosure have meanings the same as those usually understood by those skilled in the art of the disclosure. The terms used in the disclosure are only adopted to describe the embodiments of the disclosure and not intended to limit the disclosure.

Before the embodiments of the application are further described in detail, nouns and terms involved in the embodiments of the application will be described. The nouns and terms involved in the embodiments of the application are suitable for the following explanations.

1) Nginx, i.e., engine x, is a high-performance Hyper Text Transfer Protocol (HTTP) and reverse proxy web server, and may be compiled and run in most Unix Linus Operating Systems (OSs).

2) Prometheus is a service detection system, also called “Prometheus”. Prometheus is an open-source detection alerting system and time-series database developed by SoundCloud. Prometheus is developed using Go language, and is an open-source edition of a Google BorgMon detection system.

3) Federation is a federation manner that allows a piece of Prometheus service to acquire selected time-series data from another piece of Prometheus service usually to implement extension of Prometheus detection, or pull related measurement index data from the other piece of Prometheus service.

4) Consul, service discovery, configuration and management center service open-sourced by Google and developed using Go language, is embedded with a service registration and discovery framework, distributed consistency protocol implementation, health check, Key/Value storage and a multi-data center solution, and does not need to depend on other tools (for example, ZooKeeper).

5) MySQL is a relational database management system. A relational database stores data in different tables rather than stores all the data in a large warehouse, so that the speed is increased, and the flexibility is improved.

6) HTTPS, the abbreviation of Hyper Text Transfer Protocol over SecureSocket Layer, is an HTTP channel that aims at security, and the security of a transmission process is ensured by transmission encryption and identity authentication based on HTTP.

Embodiments of the disclosure provide a scene detection method and apparatus, an electronic device and a computer storage medium, which may improve the detection flexibility and detection effect of an implementation situation of a table game. An exemplary application of the electronic device provided in the embodiments of the disclosure will be described below. The electronic device provided in the embodiments of the disclosure may be implemented as an intelligent game device, such as an intelligent game table for a board game, or may be implemented various types of user terminals such as a notebook computer, a tablet computer, a desktop computer, a set-top box, and a mobile device (for example, a mobile phone, a portable music player, a personal digital assistant, a dedicated messaging device, and a portable game device), or may be implemented as an independent physical server, or a server cluster consisting of multiple physical servers or a distributed system, or a cloud server that provides basic cloud computing service such as cloud service, a cloud database, cloud computing, a cloud function, cloud storage, network service, cloud communication, middleware service, domain name service, security service, a Content Delivery Network (CDN), and a big data and artificial intelligence platform. However, the electronic device is not limited thereto.

In the following embodiments of the disclosure, the electronic device may specifically be implemented as an edge device, a first cloud, or a second cloud.

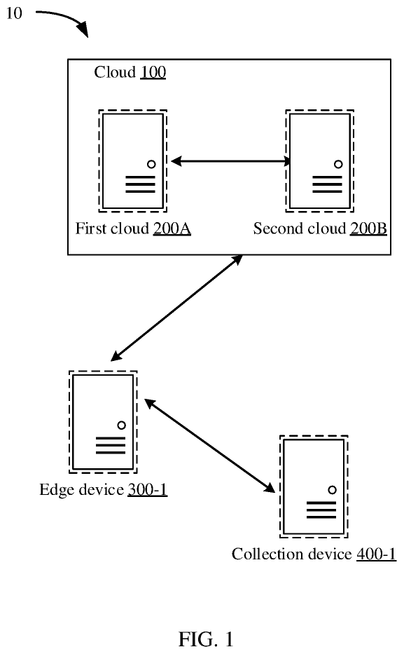

Referring to FIG. 1, FIG. 1 is an optional architecture diagram of a scene detection system 10 according to an embodiment of the disclosure. The scene detection system 10 includes a cloud 100, multiple edge devices 300, and multiple collection devices 400. The cloud 100 includes a first cloud 200A and a second cloud 200B. The first cloud 200A communicates with the second cloud 200B. The cloud 100 communicates with the multiple edge devices 300 (an edge device 300-1 is exemplarily shown). The edge device 300 communicates with the collection device 400 (a collection device 400-1 is exemplarily shown).

A first detection system component is arranged in the edge device 300-1. The edge device 300-1 is configured to acquire its own device running data through the first detection system component. The device running data acquired by the edge device 300-1 and scene information collected by the collection device 400-1 are pulled to the cloud. In the cloud 100, a second detection system component is arranged in the first cloud 200A. The first cloud 200A is configured to, through the second detection system component, detect a first device state of the edge device 300-1 according to the device running data and detect a second device state of the collection device 400-1 according to the scene information, and in a case where both the first device state and the second device state are normal, detect a scene state (for example, a game state) according to a present frame of scene image in the scene information and a stored configuration file to obtain a detection result for another business to use. In a case of a detection exception of the cloud (in a case where exceptions occur to both the first cloud 200A and the second cloud 200B), the edge device 300-1 detects its own first device state according to the device running data, detects the second device state of the collection device 400-1 based on the scene information collected by the collection device 400-1, and in a case where both the first device state and the second device state are normal, detects the scene state (for example, the game state) according to the present frame of scene image in the scene information and a locally stored configuration file to obtain the detection result for the other business to use.

In the cloud 100, a third detection system component is arranged in the second cloud 200B. The second cloud 200B is configured to, in a case where the first cloud is abnormal, through the third detection system component, detect the first device state of the edge device 300-1 according to the device running data and detect the second device state of the collection device 400-1 according to the scene information, and in a case where both the first device state and the second device state are normal, detect the scene state (for example, the game state) according to the present frame of scene image in the scene information and a stored configuration file to obtain the detection result for the other business to use.

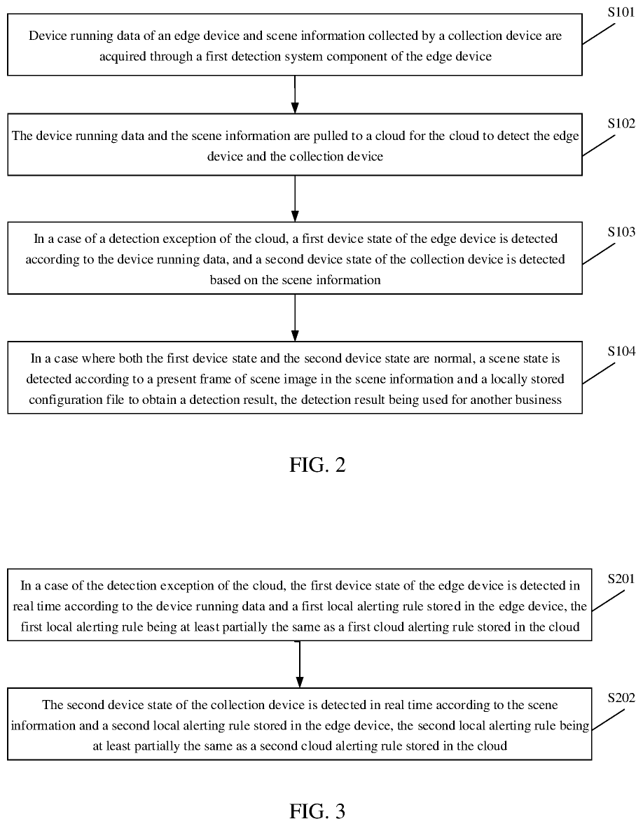

Referring to FIG. 2, FIG. 2 is an optional flowchart of a scene detection method according to an embodiment of the disclosure. The method is applied to an edge device. Descriptions will be made in combination with steps shown in FIG. 2.

In S101, device running data of the edge device and scene information collected by a collection device are acquired through a first detection system component of the edge device.

In the embodiment of the disclosure, Prometheus is arranged in the edge device. Through Prometheus, the edge device may acquire its own device running data such as a utilization rate of a Central Processing Unit (CPU) and a data processing speed and receive the scene information collected by the collection device in a specific scene, to obtain the device running data and the scene information.

In the embodiment of the disclosure, the specific scene may be an intelligent table game scene. A scene type is not limited in the embodiment of the disclosure. In the embodiment, descriptions will be made with the intelligent table game scene as an example.

In the embodiment of the disclosure, the edge device may acquire its own device running data according to a preset frequency. The preset frequency may be set as practically required. No limits are made thereto in the embodiment of the disclosure.

In the intelligent table game scene of the embodiment of the disclosure, each intelligent game table is provided with a collection device. Scene information on an intelligent game table may be collected through the corresponding collection device. The scene information may include at least one present frame of scene image.

In some embodiments of the disclosure, the collection device may be a detection camera. Here, an intelligent game table may be provided with one detection camera, or may be provided with multiple detection cameras. No limits are made thereto in the disclosure. In some other embodiments of the disclosure, besides the detection camera, the collection device may further include a gravity sensor. The gravity sensor may be arranged in some specific regions to detect weights of objects, for example, weights of props, placed in the specific regions. The number of the gravity sensor is also not limited in the disclosure.

In S102, the device running data and the scene information are pulled to a cloud for the cloud to detect the edge device and the collection device.

In the embodiment of the disclosure, the acquired device running data of the edge device and the received scene information collected by the collection device may be pulled to the cloud through a pulling operation of the cloud for the cloud to detect the states of the edge device and the collection device.

In S103, in a case of a detection exception of the cloud, a first device state of the edge device is detected according to the device running data, and a second device state of the collection device is detected based on the scene information.

In the embodiment of the disclosure, in the case of the detection exception of the cloud for the edge device and the collection device, the edge device may detect its own first device state according to its own device running data that is acquired to determine whether its own first device state is normal, and detect the second device state of the collection device according to the acquired scene information collected by the collection device to determine whether the second device state of the collection device is also normal.

In the embodiment of the disclosure, in the case of not discovering the pulling operation of the cloud in preset time, the edge device may determine the detection exception of the cloud and start detecting the states of the edge device and the collection device respectively. In some other embodiments of the disclosure, the edge device may send a query message to the cloud according to a certain preset frequency, and in the case of not receiving any response message of the cloud after a period of time, determine the detection exception of the cloud and start detecting the states of the edge device and the collection device respectively.

In S104, in a case where both the first device state and the second device state are normal, a scene state is detected according to a present frame of scene image in the scene information and a locally stored configuration file to obtain a detection result, the detection result being used for another business.

In the embodiment of the disclosure, in the case of determining, according to its own device running data, that its own first device state is normal and determining, according to the scene information collected by the collection device, that the second device state of the collection device is normal, the edge device may perform table game information identification or perform biological feature identification, table game information identification, etc., on the present frame of scene image according to the present frame of scene image in the scene information and multiple configuration files locally stored in the edge device to detect the scene state (for example, a game state and a table game state), thereby obtaining the detection result for the other business to use. For example, a business of detecting the table game state is executed using the detection result.

It is to be noted that, in the intelligent table game scene, a local memory of the edge device stores multiple configuration files of a game table. In the embodiment of the disclosure, an intelligent game table corresponds to an edge device. For example, a first edge device corresponds to a first intelligent game table, the first edge device includes multiple first table game configuration files of the first intelligent game table, and each first table game configuration file corresponds to a type of part configurations of the first intelligent game table.

In some embodiments of the disclosure, the multiple configuration files of the game table may include a collection part configuration file corresponding to the collection device, a tabletop part configuration file of the table game, etc.

Exemplarily, a collection part is a detection camera, and the collection part configuration file may include an enabled camera configuration file, a camera angle configuration file, and other types. A tabletop part of the table game may include a game object of the table game and a game region of the table game, and the tabletop part configuration file of the table game may include a table game region configuration file, a game object configuration file of the table game, etc. It is to be noted that the same part of different intelligent game tables may include the same configuration file, or may include different configuration files. No limits are made thereto in the embodiments of the disclosure.

In the embodiments of the disclosure, the edge device may identify a practical biological feature and practical table game information in the at least one present frame of scene image, match the practical biological feature and the practical table game information with a related configuration file in the multiple configuration files of the game table, and determine an obtained matching result as the detection result. Here, the matching result is configured to represent whether the practical biological feature and the practical table game information are consistent with a configuration of the related configuration file.

In the embodiments of the disclosure, the edge device, after obtaining the detection result, may prompt a player at the intelligent game table according to the detection result and a preset prompting manner. In the embodiments of the disclosure, the preset prompting manner may be producing a prompting tone, or turning on an indicator lamp, or making a voice prompt. No limits are made in the embodiments of the disclosure.

In the embodiments of the disclosure, the biological feature may be features of each organ of a human body, such as the face, a hand action, and a body action. Biological feature identification may be identification of the features of each organ of the human body or associated identification between the features of each organ of the human body.

Exemplarily, violating body actions are configured in the multiple configuration files of the game table. As such, the edge device performs human identification on the at least one present frame of scene image to obtain a body action of the player, compares with the body action of the player and the violating body actions, and when the body action of the player is matched with a violating body action, prompts the player that the action violates a rule.

In the embodiments of the disclosure, the table game information may include the game object of the table game. Here, the game object of the table game may include a game tool of the table game, for example, cards and tokens. The game object of the table game may also include a game rule of the table game, for example, a dealing sequence, a card showing rule, and card showing time. The table game information may further include the game region of the table game, for example, a dealing region, a card showing region, and a token region.

Exemplarily, the multiple configuration files of the table game include a token region configuration file. The edge device performs token region identification on the at least one present frame of scene image to obtain the token region. As such, the edge device may detect whether the token is in the token region, and in a case where the game current is not in the token region, prompts the player to place the token in the token region.

In the embodiments of the disclosure, in the intelligent table game scene, since the edge device and the cloud may detect the edge device and the collection device respectively, a failure of a cloud device may not affect detection of the edge device and the collection device by the edge device. In the case of detecting that the states of the edge device and the collection device are normal, the edge device may further detect the scene state according to the present scene image collected by the collection device and the locally stored related configuration file to obtain the detection result that may be used for the other business, so that an implementation situation of a scene such as the intelligent table game may be detected conveniently, normal implementation of the scene such as the intelligent table game is facilitated, and the detection flexibility and detection effect of the implementation situation of the scene such as the intelligent table game are further improved.

In some embodiments of the disclosure, the operation in S103 that, in the case of the detection exception of the cloud, the first device state of the edge device is detected according to the device running data and the second device state of the collection device is detected based on the scene information may be implemented by S201 to S202, as shown in FIG. 3.

In S201, in the case of the detection exception of the cloud, the first device state of the edge device is detected in real time according to the device running data and a first local alerting rule stored in the edge device, the first local alerting rule being at least partially the same as a first cloud alerting rule stored in the cloud.

In S202, the second device state of the collection device is detected in real time according to the scene information and a second local alerting rule stored in the edge device, the second local alerting rule being at least partially the same as a second cloud alerting rule stored in the cloud.

In the embodiments of the disclosure, since the edge device and the collection device play different roles, the edge device may use two different local alerting rules to determine whether the device running data of the edge device is consistent with an exceptional event in the first local alerting rule corresponding to the edge device and determine whether the scene information collected by the collection device is consistent with an exceptional event in the second local alerting rule corresponding to the edge device, to detect the device state of the edge device and the device state of the collection device respectively.

In the embodiments of the disclosure, an alerting rule includes an exceptional event about which an alert is required to be given, and an alerting manner when the exceptional event occurs. In some embodiments of the disclosure, the exceptional event in the first local alerting rule stored in the edge device is the same as the exceptional event in the first cloud alerting rule stored in the cloud, but an alerting manner in the first local alerting rule is different from an alerting manner in the first cloud alerting rule stored in the cloud. Correspondingly, the exceptional event in the second local alerting rule stored in the edge device is the same as the exceptional event in the second cloud alerting rule stored in the cloud, but an alerting manner in the second local alerting rule is different from an alerting manner in the second cloud alerting rule stored in the cloud. For example, the alerting manner in the first local alerting rule/second local alerting rule is alerting through an alerting component such as an indicator lamp and a speaker, while the alerting manner in the first cloud alerting rule/second cloud alerting rule is alerting by sending alert information to a related service device. That is, for the same exceptional event, the edge device and the cloud may alert using different alerting manners.

In some other embodiments of the disclosure, the exceptional event in the first local alerting rule stored in the edge device is the same as the exceptional event in the first cloud alerting rule stored in the cloud, and the alerting manner in the first local alerting rule is also the same as the alerting manner in the first cloud alerting rule stored in the cloud. Correspondingly, the exceptional event in the second local alerting rule stored in the edge device is the same as the exceptional event in the second cloud alerting rule stored in the cloud, and the alerting manner in the second local alerting rule is also the same as the alerting manner in the second cloud alerting rule stored in the cloud. For example, the alerting manners in all the first local alerting rule, the second local alerting rule, the first cloud alerting rule and the second cloud alerting rule are alerting by sending the alert information to the related service device.

It can be understood that, in the embodiments of the disclosure, the edge device may detect the device states of the edge device and the collection device using different alerting rules respectively, and the alerting rules stored in the edge device are at least partially the same as the alerting rules stored in the cloud, so that the diversity of detecting the edge device and the collection device may be achieved.

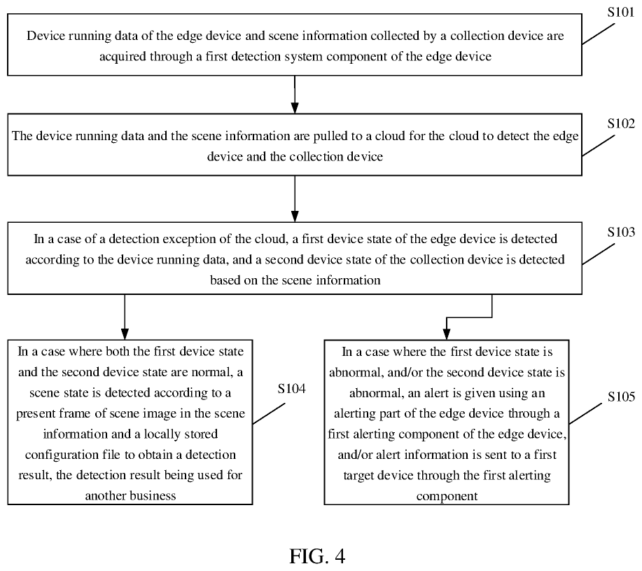

In some embodiments of the disclosure, as shown in FIG. 4, after S103 in FIG. 1, S105 may further be executed.

In S105, in a case where the first device state is abnormal, and/or the second device state is abnormal, an alert is given using an alerting part of the edge device through a first alerting component of the edge device, and/or alert information is sent to a first target device through the first alerting component.

In some embodiments of the disclosure, in the case of detecting that the first device state of the edge device is abnormal, or the second device state of the collection device is abnormal, or both the first device state of the edge device and the second device state of the collection device is abnormal, the edge device may control its own alerting part such as the loudspeaker and the indicator lamp to send the alert information through the first alerting component. In some other embodiments of the disclosure, in the case of detecting that the first device state of the edge device is abnormal, or the second device state of the collection device is abnormal, or both the first device state of the edge device and the second device state of the collection device is abnormal, the edge device may control, through the first alerting component, the alert information to be sent to the service device related to the scene such as the intelligent table game for alerting. For example, the edge device may send all of failure description information of a reason, time point, etc., of a failure and prompting information to the service device related to the scene such as the intelligent table game for a person using the service device to implement checking and maintenance.

In the embodiments of the disclosure, the edge device, when finding an exception of the edge device and/or the collection device, may send the prompting information through its own indicator lamp, loudspeaker and other parts, or, may send the alert information to the service device related to the scene to implement upward feedback of the alert information, to enable a related person to timely know the exception, so that the intelligence is improved.

In some embodiments of the disclosure, the situation where the first device state is normal includes at least one of the following: a utilization rate of a processor is less than or equal to a preset utilization rate value, a time consumption for data processing is less than or equal to a preset time consumption threshold, or a frequency of acquiring the device running data is less than or equal to a preset frequency threshold.

In the embodiments of the disclosure, since the edge device is required to acquire its own device running data for data processing of the edge device or the cloud, and in a case where the cloud fails, the edge device is required to perform data processing on its own device running data and the scene information collected by the collection device, in a case where the utilization rate of the processor of the edge device is greater than the preset utilization rate threshold, the time consumption for data processing is greater than the preset time consumption threshold, or the frequency of acquiring the device running data is less than the preset frequency threshold, detection of the device states of the edge device and the collection device by the cloud may be affected, or detection of the device states of the edge device and the collection device by the edge device may be affected, and furthermore, there may be brought such a situation where a failure of the collection device cannot be found timely when occurring because the collection device cannot be detected effectively to further affect detection of the scene state and finally affect normal running of the other business related to the table game. Therefore, under at least one of the conditions that the utilization rate of the processor of the edge device is less than or equal to the preset utilization rate threshold, the time consumption for data processing is less than or equal to the preset time consumption threshold, or the frequency of acquiring the device running data by the edge device is more than or equal to the preset frequency threshold, it is determined that the first device state of the edge device is normal, the cloud may detect the device states of the edge device and the collection device, or the edge device may detect the device states of the edge device and the collection device normally, furthermore, influences on detection of the scene state are eliminated, and the other business related to the table game may be implemented normally.

In the embodiments of the disclosure, the edge device may determine by comparison a magnitude relationship between any parameter in the utilization rate of its own processor, its own time consumption for data processing and its own frequency of acquiring the device running data and the corresponding threshold to determine whether the edge device is in an abnormal state accurately, thereby implementing accurate detection of the device state of the edge device.

In some embodiments of the disclosure, the situation where the second device state is normal includes at least one of the following: the present frame of scene image exists in the scene information, or a region corresponding to the present frame of scene image is a preset collection region.

In the embodiments of the disclosure, the collection device may collect scene images on the corresponding intelligent game table according to a preset frequency, for example, collecting images of the token region on the intelligent game table, for subsequent detection of the token in the token region, detection of a gaming stage, etc. In a case where the collection device fails at a certain collection moment, the collection device cannot collect any image of the token region, or, in a case where the collection device collects an image of not the token region but a game prop operator at a certain collection moment, detection of the token in the token region, the gaming stage, etc., cannot be continued subsequently, thereby affecting normal running of the other business related to the table game. Therefore, under the present frame of scene image exists in the scene information collected by the collection device, and/or, the region corresponding to the present frame of scene image is the preset collection region, it is determined that the second device state of the collection device is normal, and the other business related to the table game may be implemented normally.

In the embodiments of the disclosure, the edge device may judge whether the present frame of scene image exists in the scene information or judge whether the region corresponding to the present frame of scene image is the preset collection region to obtain the device state of the collection device accurately, thereby implementing accurate detection of the device state of the collection device.

In some embodiments of the disclosure, the operation in S102 that the device running data and the scene information are pulled to the cloud for the cloud to detect the edge device and the collection device may be implemented by S1021.

In S201, the device running data and the scene information are pulled to the cloud using a federation manner of the first detection system component through a gateway component of the edge device for the cloud to detect the edge device and the collection device. The gateway component is arranged in the edge device.

In the embodiments of the disclosure, the gateway component Nginx is arranged in the edge device. The device running data of the edge device and the received scene information sent by the collection device may be pulled to the cloud by federation, so that the cloud may detect the device states of the edge device and the collection device according to the obtained device running data and scene information.

Here, Nginx supports HTTP, and transmitting the scene information and the device running data using HTTP may implement the security of data transmission, so that the risk of leakage of table game data related to the table game is reduced. Through the federation manner, the cloud may pull data of each edge in real time conveniently, so that the timeliness of data acquisition may be improved.

In the embodiments of the disclosure, the edge device is registered with the cloud in a case where its own first detection system component is enabled, and then the cloud may detect the edge device timely, so that the timeliness of detecting the edge device and the collection device by the cloud is improved.

In some embodiments of the disclosure, after S101 and before S102, S301 may further be executed.

In S301, in a case where the first detection system component is run, registration information including a device identifier of the edge device is sent to the cloud for the cloud to determine the edge device as an object to be detected according to the registration information.

In the embodiments of the disclosure, if the edge device starts running the first detection system component, it indicates that detection service deployed in the edge device has been enabled. In such case, the edge device acquires its own device identifier, and sends the registration information containing its own device identifier to the cloud such that the cloud knows that the edge device is on-line and the cloud starts detecting the edge device. It is to be noted that each edge device has a device identifier, and device identifiers of different edge devices are different.

In the embodiments of the disclosure, the edge device is registered with the cloud in a case where its own first detection system component is enabled, and then the cloud may detect the edge device timely, so that the timeliness of detecting the edge device and the collection device by the cloud is improved.

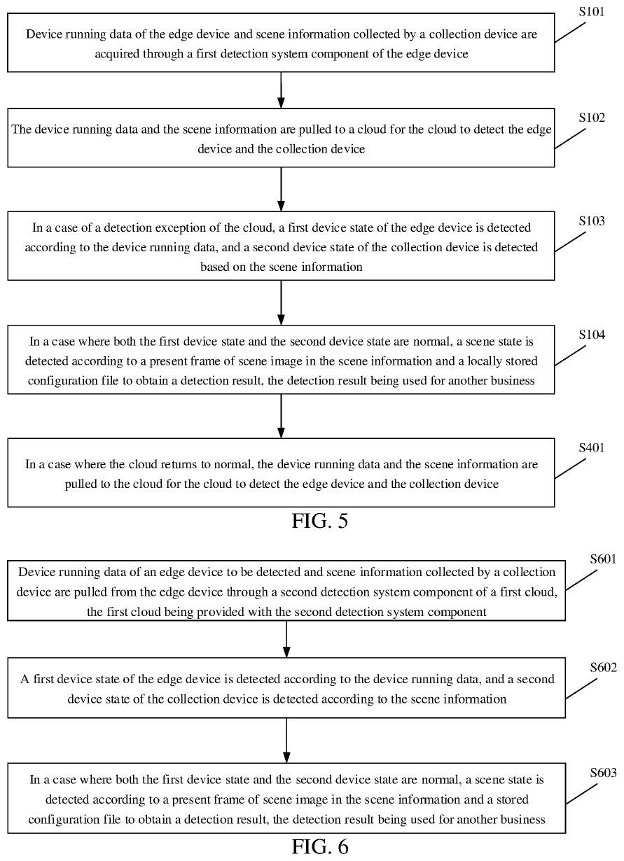

In some embodiments of the disclosure, after S103, S401 may further be executed. Exemplarily, as shown in FIG. 5, after S104, S401 may be executed.

In S401, in a case where the cloud returns to normal, the device running data and the scene information are pulled to the cloud for the cloud to detect the edge device and the collection device.

In the embodiments of the disclosure, in a case where the cloud returns to normal, the edge device continues to allow the device running data and the scene information to be pulled by the cloud for the cloud to detect the device states of the edge device and the collection device.

In some embodiments of the disclosure, the edge device learns that the cloud has returned to normal when detecting the pulling operation of the cloud. In some other embodiments of the disclosure, after the detection exception of the cloud occurs, the edge device may periodically send the query message to the cloud, and after receiving a response message of the cloud, learns that the cloud has returned to normal.

In the embodiments of the disclosure, the edge device sends its own running data and the scene information sent by the collection device to the cloud in a case where the cloud returns to normal, and then the cloud may continue to detect the edge device and the collection device, so that switching from detection by the edge device to detection by the cloud is implemented.

In some embodiments of the disclosure, after S102, S501 may further be executed.

In S501, in a case of an own failure, the device running data and the scene information are stopped to be pulled to the cloud to stop the cloud from detecting the edge device and the collection device.

In the embodiments of the disclosure, in a case of an own failure and thus the edge device cannot acquire its own device running data and/or cannot receive the scene information sent by the collection device, the edge device stops allowing its own data to be pulled by the cloud to stop the cloud from detecting the device states of the edge device and the collection device.

In the embodiments of the disclosure, the edge device interrupts data transmission with the cloud in a case of an own failure, so that the cloud may judge whether data transmission with the edge device is normal to detect the edge device to timely know the exception of the edge device.

The embodiments of the disclosure also provide a scene detection method. The method is applied to a first cloud. The first cloud is provided with a second detection system component. Referring to FIG. 6, FIG. 6 is an optional flowchart of a scene detection method according to an embodiment of the disclosure. The method is applied to the first cloud. Descriptions will be made in combination with steps shown in FIG. 6.

In S601, device running data of an edge device to be detected and scene information collected by a collection device are pulled from the edge device through a second detection system component of the first cloud. The first cloud is provided with the second detection system component.

In S602, a first device state of the edge device is detected according to the device running data, and a second device state of the collection device is detected according to the scene information.

In S603, in a case where both the first device state and the second device state are normal, a scene state is detected according to a present frame of scene image in the scene information and a stored configuration file to obtain a detection result, the detection result being used for another business.

In the embodiment of the disclosure, a specific scene may be an intelligent table game scene. A scene type is not limited in the embodiment of the disclosure. In the embodiment, descriptions will be made with the intelligent table game scene as an example.

In the embodiment of the disclosure, Prometheus is also arranged in the first cloud. The first cloud acquires, through Prometheus, the device running data of the edge device and the scene information that is sent to the edge device and collected by the collection device in the intelligent table game scene from the edge device required to be detected, determines whether the device states of the edge device and the collection device are normal according to the acquired information, and in the case of determining that the device states of the edge device and/or the collection device are normal, performs table game information identification or perform biological feature identification and table game information identification on the present frame of scene image according to the present frame of scene image in the scene information and multiple configuration files, stored in the first cloud, of a game table to detect the scene state (for example, a game state or a table game state), thereby obtaining the detection result for the other business to use. For example, a business of detecting the table game state is executed using the detection result.

In the embodiments of the disclosure, since the cloud detects the device states of the edge device and the collection device according to the device running data of the edge device and the scene information collected by the collection device respectively, and in a case where the states of the edge device and the collection device are normal, may detect the scene state according to the present scene image collected by the collection device and the locally stored related configuration file to obtain the detection result that may be used for the other business, so that an implementation situation of a specific scene (for example, a table game) may be detected conveniently, normal implementation of the scene is facilitated, and the detection flexibility and detection effect are further improved.

In some embodiments of the disclosure, the operation in S602 that the first device state of the edge device is detected according to the device running data and the second device state of the collection device is detected according to the scene information may be implemented by S701 to S702.

In S701, the first device state of the edge device is detected in real time according to the device running data and a first cloud alerting rule stored in the cloud, the first cloud alerting rule being at least partially the same as a first local alerting rule stored in the edge device.

In S702, the second device state of the collection device is detected in real time according to the scene information and a second cloud alerting rule stored in the cloud, the second cloud alerting rule being at least partially the same as a second local alerting rule stored in the edge device.

In the embodiments of the disclosure, an alerting rule includes an exceptional event about which an alert is required to be given, and an alerting manner when the exceptional event occurs. In some embodiments of the disclosure, an exceptional event in the first cloud alerting rule stored in the first cloud is the same as an exceptional event in the first local alerting rule stored in the edge device, but an alerting manner in the first cloud alerting rule stored in the first cloud is different from an alerting manner in the first local alerting rule. Correspondingly, an exceptional event in the second cloud alerting rule stored in the first cloud is the same as an exceptional event in the second local alerting rule stored in the edge device, but an alerting manner in the second cloud alerting rule stored in the first cloud is different from that in the second local alerting rule stored in the edge device. For example, the alerting manner in the first cloud alerting rule/second cloud alerting rule is alerting by sending alert information to a related service device, while the alerting manner in the first local alerting rule/second local alerting rule is alerting through an alerting component such as an indicator lamp and a loudspeaker.

In some other embodiments of the disclosure, the exceptional event in the first cloud alerting rule stored in the first cloud is the same as the exceptional event in the first local alerting rule stored in the edge device, and the alerting manner in the first cloud alerting rule stored in the first cloud is also the same as the alerting manner in the first local alerting rule. Correspondingly, the exceptional event in the second cloud alerting rule stored in the first cloud is the same as the exceptional event in the second local alerting rule stored in the edge device, and the alerting manner in the second cloud alerting rule stored in the first cloud is also the same as the alerting manner in the second local alerting rule. For example, the alerting manners in all the first local alerting rule, the second local alerting rule, the first cloud alerting rule and the second cloud alerting rule are alerting by sending the alert information to the related service device.

In the embodiments of the disclosure, the cloud may detect the device states of the edge device and the collection device using different alerting rules respectively, and the alerting rules stored in the cloud are at least partially the same as the alerting rules stored in the edge device, so that the diversity of detecting the edge device and the collection device may be achieved.

In some embodiments of the disclosure, after S102, S801 may further be executed.

In S801, in a case where the first device state is abnormal, and/or the second device state is abnormal, alert information is sent to a second target device through a second alerting component. The second target device includes a service device related to the scene such as the intelligent table game and an Email server. The second alerting component is arranged in the first cloud.

In the embodiments of the disclosure, in the case of determining that the first device state of the edge device is abnormal, or the second device state of the collection device is abnormal, or both the first device state of the edge device and the second device state of the collection device are abnormal, the first cloud controls, through its own second alerting component, the alert information to be sent to the service device related to the scene such as the intelligent table game and the Email server for a person using the service device to implement checking and maintenance and implement upward feedback of the alert information through the Email server.

It is to be noted that the first cloud may simultaneously detect multiple edge devices and multiple collection devices. When the first cloud determines that a device state of a certain edge device or a certain collection device is abnormal, the first cloud controls, through its own second alerting component, alert information related to the edge device or the collection device to be sent to the service device related to the scene such as the intelligent table game and the Email server to make such a prompt that the device state of the edge device or the collection device is abnormal.

In the embodiments of the disclosure, in a case where an exception occurs to the edge device and/or the collection device, the cloud may send the alert information to the service device related to the scene and the Email server to implement upward feedback of the alert information to enable a related person to timely know the exception.

In some embodiments of the disclosure, before S601, S901 to S902 may further be executed.

In S901, through a service discovery component of the cloud, registration information including a device identifier of an edge device is received from the edge device in real time, and a device identifier of an edge device that stops running a first detection system component is determined in real time. The service discovery component is arranged in the first cloud.

In the embodiments of the disclosure, the edge device may be on-line or off-line. In a case where an edge device is off-line, the first cloud may stop detecting the edge device. In a case where an edge device is on-line, the edge device may send its own device identifier to the first cloud, and the first cloud starts detecting the edge device. Moreover, the first cloud maintains a device list, and detects a related edge device according to the list. The first cloud may receive registration information that is sent by an on-line edge device and includes a device identifier of the edge device in real time through Consul to obtain the device identifier of the on-line edge device, and through Consul, determine a detected edge device stops running its own Prometheus in real time and determine a device identifier of the edge device that stops running its own Prometheus from the device list to obtain the device identifier of the off-line edge device. Here, the first cloud may configure the edge device required to be detected flexibly and conveniently through Consul, so that the flexibility of detecting the edge device is improved.

In S902, an updated device list is obtained based on the device identifiers through the second detection system component by adding the device identifier of the edge device that sends the registration information to a device list and deleting the device identifier of the edge device that stops running the first detection system component from the device list, and the edge device corresponding to the device identifier in the updated device list is determined as the edge device to be detected.

In the embodiments of the disclosure, in the case of obtaining the device identifier of the on-line edge device and/or the device identifier of the off-line edge device, the first cloud may maintain the device list through its own Prometheus by adding the device identifier of the on-line edge device to the device list and deleting the device identifier of the off-line edge device from the device list to obtain a new device list, and detect the corresponding edge device according to the device identifier in the new device list.

In the embodiments of the disclosure, the device list may be maintained and updated timely according to on-line and off-line states of the edge devices to detect the on-line edge device timely and stop detecting the off-line edge device timely. As such, a utilization rate of a detection resource of the first cloud may be improved, and the timeliness of detecting the edge device and the collection device by the first cloud may be improved.

In some embodiments of the disclosure, S601 may be implemented by S1001.

In S1001, the device running data of the edge device to be detected and the scene information collected by the collection device are pulled from the edge device using a federation manner of the second detection system component through a gateway component of the first cloud.

In the embodiments of the disclosure, the gateway component Nginx is arranged in the first cloud. The first cloud may pull the device running data of the edge device and the scene information sent by the collection device by federation of Prometheus, thereby detecting the device states of the edge device and the collection device according to the obtained device running data and the scene information in the intelligent table game scene.

In the embodiments of the disclosure, the cloud implements data transmission with the edge device through its own gateway component and the federation manner, so that the timeliness of data transmission may be improved, and the device states of the edge device and the collection device may be detected conveniently.

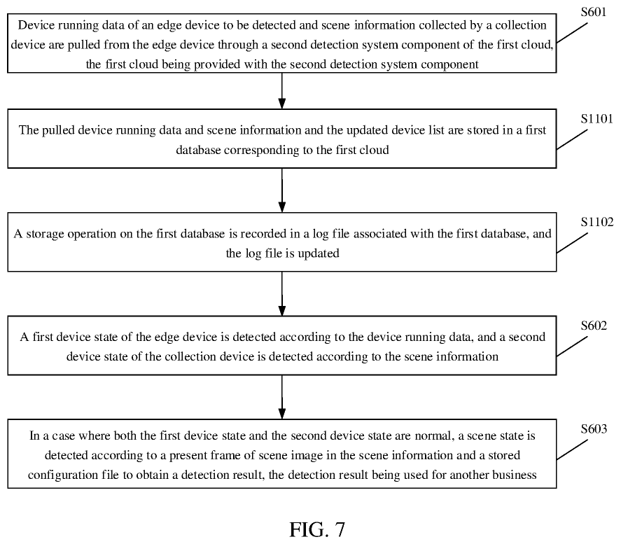

In some embodiments of the disclosure, after S601, S1101 to S1102 may further be executed. Referring to FIG. 7, FIG. 7 is an optional flowchart of a scene detection method according to an embodiment of the disclosure. As shown in FIG. 7, after S601 in FIG. 6 and before S602, S1101 to S1102 may be executed. Descriptions will be made in combination with the steps shown in FIG. 6.

In S1101, the pulled device running data and scene information and the updated device list are stored in a first database corresponding to the first cloud.

In S1102, a storage operation on the first database is recorded in a log file associated with the first database, and the log file is updated.

In the embodiments of the disclosure, the first cloud corresponds to a MySQL database. The first cloud may store the device running data and the scene information in the first database after pulling the device running data and the scene information from the edge device, and store the new device list in the first database after obtaining the new device list, and after performing the storage operation on the MySQL database, may record all operations over the MySQL database in the log file associated with the MySQL database. Exemplarily, in a case where an operation, for example, a storage/deletion operation, is performed on the MySQL database, a corresponding operation record may be generated in the log file, the record recording the specific operation on the MySQL database in detail.

In the embodiments of the disclosure, the cloud stores all received and obtained data in the first database, records the storage operation on the first database in the log file, and updates the log file, so that data backup may be implemented, and the other device may implement data synchronization conveniently according to the log file.

It is to be noted that an execution sequence in FIG. 7 is an example. In some other embodiments of the disclosure, S1101 to S1102 may be executed at the same time of S602 to S603, or, S1101 to S1102 may be executed after S602 to S603. No limits are made thereto in the embodiments of the disclosure.

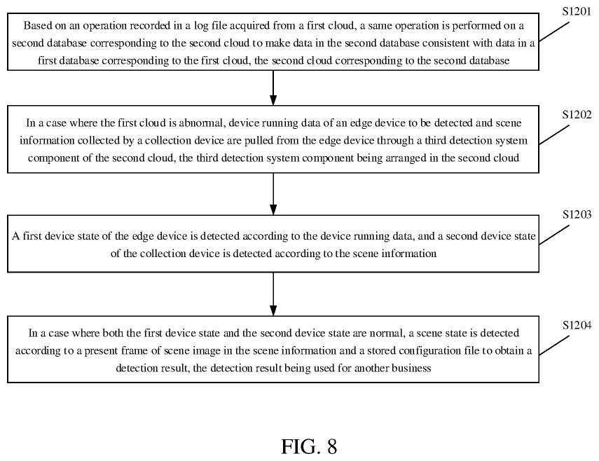

The embodiments of the disclosure provide a scene detection method. The method is applied to a second cloud. A third detection system component is arranged in the second cloud, and the second cloud corresponds to a second database. Referring to FIG. 8, FIG. 8 is an optional flowchart of a scene detection method according to an embodiment of the disclosure. The method is applied to the second cloud. Descriptions will be made in combination with steps shown in FIG. 8.

In S1201, based on an operation recorded in a log file acquired from a first cloud, the same operation is performed on a second database corresponding to the second cloud to make data in the second database consistent with data in a first database corresponding to the first cloud. The second cloud corresponds to the second database.

In the embodiment of the disclosure, the second cloud also corresponds to a MySQL database. The second cloud may acquire the log file from the first cloud according to a preset frequency, and perform the same operation on the MySQL database corresponding to the second cloud according to the operation of the first cloud over the first database in the log file to make the data in the second database corresponding to the second cloud consistent with the data in the first database corresponding to the first cloud, so that the second cloud may subsequently continue to detect the edge device and the collection device when the first cloud fails.

In S1202, in a case where the first cloud is abnormal, device running data of an edge device to be detected and scene information collected by a collection device are pulled from the edge device through a third detection system component of the second cloud. The third detection system component is arranged in the second cloud.

In the embodiments of the disclosure, Prometheus is also arranged in the second cloud. The second cloud may pull the device running data of the edge device and the scene information collected by the collection device in an intelligent game table scene by federation of Prometheus, thereby continuing to detect the device states of the edge device and the collection device according to the obtained device running data and scene information.

In some embodiments of the disclosure, the second cloud may determine that the first cloud is abnormal in a case where the log file cannot be acquired from the first cloud. In some other embodiments of the disclosure, the second cloud may also intermittently send a query message to the first cloud, and in the case of not receiving any response message of the first cloud after a period of time, determine that the first cloud is abnormal.

In S1203, a first device state of the edge device is detected according to the device running data, and a second device state of the collection device is detected according to the scene information.

In S1204, in a case where both the first device state and the second device state are normal, a scene state is detected according to a present frame of scene image in the scene information and a stored configuration file to obtain a detection result, the detection result being used for another business.

In the embodiment of the disclosure, The second cloud acquires, through Prometheus, the device running data of the edge device and the scene information that is sent to the edge device and collected by the collection device from the edge device required to be detected, determines whether the device states of the edge device and the collection device are normal according to all the acquired information, and in the case of determining that the device states of the edge device and/or the collection device are normal, performs table game information identification or perform biological feature identification and table game information identification on the present frame of scene image according to the present frame of scene image in the scene information and multiple configuration files, stored in the second cloud, of a game table to detect the scene state (for example, a game state or a table game state), thereby obtaining the detection result for the other business to use. For example, a business of detecting the table game state is executed using the detection result. Therefore, an implementation situation of the scene such as the intelligent table game may be detected conveniently, normal implementation of the scene such as the intelligent table game is facilitated, and the detection flexibility and detection effect of the implementation situation of the scene such as the intelligent table game are further improved.

In the embodiment of the disclosure, a host-standby mode of a cloud may be implemented through the first cloud and the second cloud. Then, even though the host cloud (the first cloud) fails, the second cloud, as a standby cloud, may immediately be upgraded into a host cloud to continue to detect the edge device and the collection device. Therefore, high availability of detection service of the cloud is achieved.

It is to be noted that, in a case where the cloud includes the first cloud and the second cloud, and both the first cloud and the second cloud are abnormal, the edge device starts detecting the device states of the edge device and the collection device connected therewith.

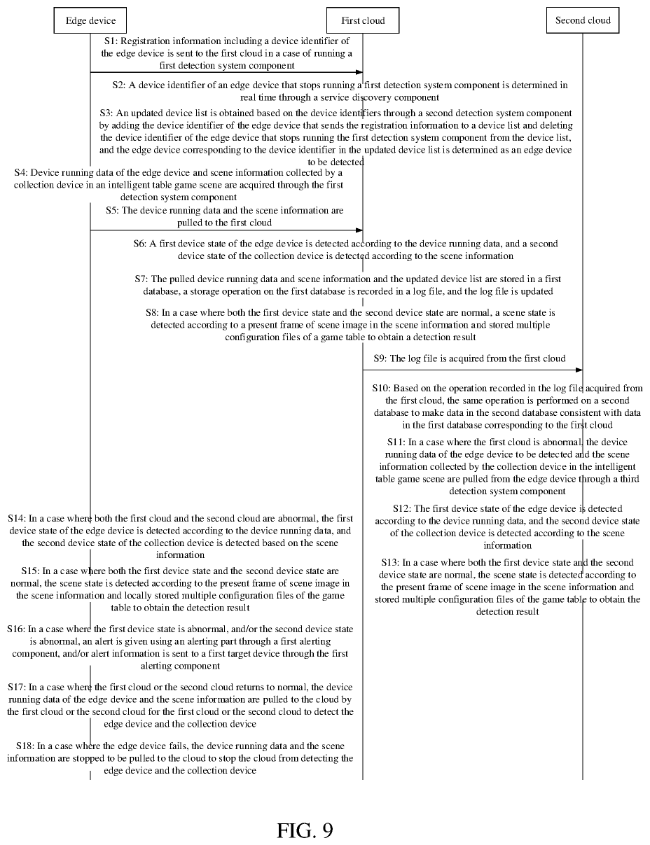

Referring to FIG. 9, FIG. 9 is an optional flowchart of a scene detection method according to an embodiment of the disclosure. The method is applied to an interaction process between an edge device and a first cloud or a second cloud and between the first cloud and the second cloud. Descriptions will be made in combination with steps shown in FIG. 9.

In S1, the edge device sends registration information including its own device identifier to the first cloud in the case of running a first detection system component.

In S2, the first cloud determines, in real time through a service discovery component, a device identifier of an edge device that stops running a first detection system component.

In S3, the first cloud obtains an updated device list based on the device identifiers through a second detection system component by adding the device identifier of the edge device that sends the registration information to a device list and deleting the device identifier of the edge device that stops running the first detection system component from the device list, and determines the edge device corresponding to the device identifier in the updated device list as an edge device to be detected.

In S4, the edge device acquires, through the first detection system component, its own device running data and scene information collected by a collection device in an intelligent table game scene.

In S5, the device running data and the scene information are pulled to the first cloud.

In S6, the first cloud detects a first device state of the edge device according to the device running data, and detects a second device state of the collection device according to the scene information.

In S7, the first cloud stores the pulled device running data and scene information and the updated device list in a first database, records a storage operation on the first database in a log file, and updates the log file.

In S8, in a case where both the first device state and the second device state are normal, the first cloud detects a scene state according to a present frame of scene image in the scene information and stored multiple configuration files of a game table to obtain a detection result.

In S9, the second cloud acquires the log file from the first cloud.

In S10, based on the operation recorded in the log file acquired from the first cloud, the second cloud performs the same operation on a second database to make data in the second database consistent with data in the first database corresponding to the first cloud.

In S11, in a case where the first cloud is abnormal, the second cloud pulls the device running data of the edge device to be detected and the scene information collected by the collection device in the intelligent table game scene from the edge device through a third detection system component.

In S12, the second cloud detects the first device state of the edge device according to the device running data, and detects the second device state of the collection device according to the scene information.

In S13, in a case where both the first device state and the second device state are normal, the second cloud detects the scene state according to the present frame of scene image in the scene information and stored multiple configuration files of the game table to obtain the detection result.

In S14, in a case where both the first cloud and the second cloud are abnormal, the edge device detects its own first device state according to the device running data, and detects the second device state of the collection device based on the scene information.

In S15, in a case where both the first device state and the second device state are normal, the edge device detects the scene state according to the present frame of scene image in the scene information and locally stored multiple configuration files of the game table to obtain the detection result.

In S16, in a case where the first device state is abnormal, and/or the second device state is abnormal, the edge device gives an alert using an alerting part through a first alerting component, and/or sends alert information to a first target device through the first alerting component.

In S17, in a case where the first cloud or the second cloud returns to normal, the device running data of the edge device and the scene information are pulled to the cloud by the first cloud or the second cloud for the first cloud or the second cloud to detect the edge device and the collection device.

In S18, in a case of an own failure, the device running data and the scene information are stopped to be pulled to the cloud to stop the cloud from detecting the edge device and the collection device.

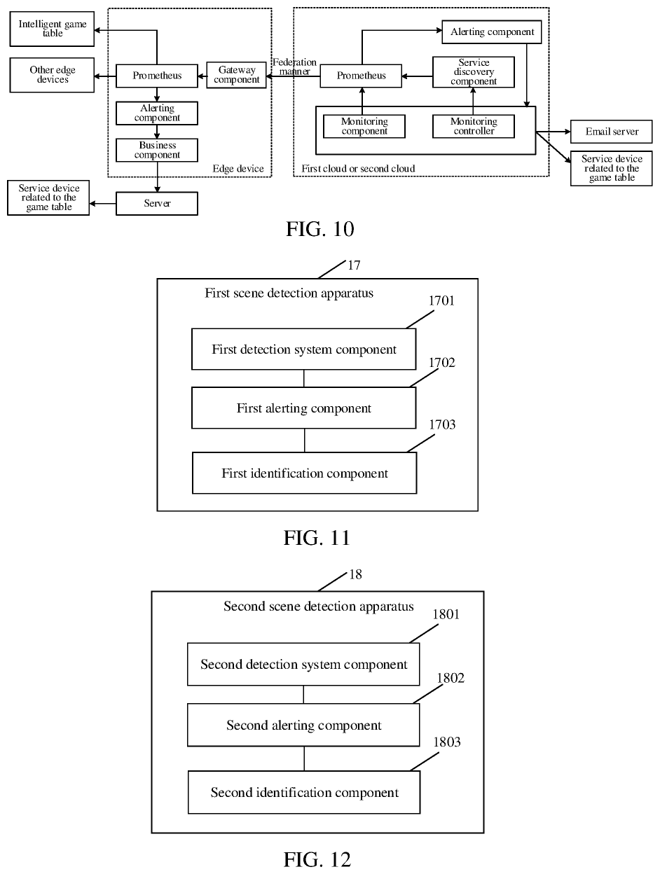

Referring to FIG. 10, FIG. 10 shows an example of an interaction process between an edge device and an intelligent game table and between the edge device and a first cloud or a second cloud as well as structure diagrams of the edge device and the first cloud or the second cloud according to an embodiment of the disclosure. As shown in FIG. 10, the edge device, through Prometheus, acquires scene information from a collection device (not shown in FIG. 10) on the intelligent game table and acquires its own device running data, and may send the scene information and the device running data to another edge device. In a case where both the first cloud and the second cloud are abnormal, the edge device sends the scene information and the device running data to an alerting component (Alert Manager) of the edge device through Prometheus for the Alert Manager to determine whether device states of the edge device and the collection device are abnormal. In a case where the device states of the edge device and/or the collection device are abnormal, a device required to learn related alert information is determined through a business component (Business), and the corresponding alert information is sent to a service device (GOM) related to the table game through a related server (GTT).

A detection controller (Management) of the first cloud or the second cloud controls the first cloud or the second cloud to discover the edge device required to be detected through a service discovery component (Consul), and the first cloud or the second cloud controls Prometheus of the first cloud or the second cloud through a detection component (Monitoring) and Consul to pull data from the edge device required to be detected. The first cloud or the second cloud may pull the device running data of the edge device and the scene information collected by the collection device from a gateway component (Nginx) of the edge device by Federation through Prometheus. The gateway component (Nginx) of the edge device may acquire the device running data and the scene information collected by the collection device from Prometheus of the edge device according to a pulling operation of the first cloud or the second cloud. The first cloud or the second cloud performs pulling through Prometheus. The first cloud or the second cloud determines whether the edge device and/or the collection device are/is abnormal through the alerting component (Alert Manager), and in a case where the edge device and/or the collection device are/is abnormal, sends the corresponding alert information to an Email server and the service device (GOM) related to the game table through Management or Monitoring.

FIG. 11 is a structure composition diagram of a first scene detection apparatus according to an embodiment of the disclosure. As shown in FIG. 11, the first scene detection apparatus 17 includes a first detection system component 1701, a first alerting component 1702 and a first identification unit 1703.

The first detection system component 1701 is configured to acquire device running data of the apparatus and scene information collected by a collection device, and pull the device running data and the scene information to a cloud for the cloud to detect the apparatus and the collection device.

The first alerting component 1702 is configured to, in a case of a detection exception of the cloud, detect a first device state of the apparatus according to the device running data, and detect a second device state of the collection device based on the scene information.

The first identification component 1703 is configured to, in a case where both the first device state and the second device state are normal, detect a scene state according to a present frame of scene image in the scene information and a locally stored configuration file to obtain a detection result, the detection result being used for another business.

In some embodiments, the first alerting component 1702 is further configured to, in the case of the detection exception of the cloud, detect the first device state of the apparatus in real time according to the device running data and a first local alerting rule stored in the apparatus, and detect the second device state of the collection device in real time according to the scene information and a second local alerting rule stored in the apparatus, the first local alerting rule being at least partially the same as a first cloud alerting rule stored in the cloud, and the second local alerting rule being at least partially the same as a second cloud alerting rule stored in the cloud.

In some embodiments, the edge device includes an alerting part. The first alerting component 1702 is further configured to, in a case where the first device state is abnormal, and/or the second device state is abnormal, give an alert using the alerting part through the first alerting component, and/or send alert information to a first target device through the first alerting component, the first target device being service device related to a scene.

In some embodiments, the situation where the first device state is normal includes at least one of the following: a utilization rate of a processor is less than or equal to a preset utilization rate value, a time consumption for data processing is less than or equal to a preset time consumption threshold, or a frequency of acquiring the device running data is less than or equal to a preset frequency threshold.

In some embodiments, the situation where the second device state is normal includes at least one of the following: the present frame of scene image exists in the scene information, or a region corresponding to the present frame of scene image is a preset collection region.

In some embodiments, the edge device includes a gateway component 1704 (not shown in the figure). The first detection system component 1701 is further configured to pull the device running data and the scene information to the cloud using a federation manner of the first detection system component through the gateway component for the cloud to detect the apparatus and the collection device.

In some embodiments, the first detection system component 1701 is further configured to, in a case where the first detection system component is run, send registration information including a device identifier of the apparatus to the cloud for the cloud to determine the apparatus as an object to be detected according to the registration information.

In some embodiments, the first detection system component 1701 is further configured to, in a case where the cloud returns to normal, pull the device running data and the scene information to the cloud for the cloud to detect the apparatus and the collection device.

In some embodiments, the first detection system component 1701 is further configured to, in a case of an own failure, stop pulling the device running data and the scene information to the cloud to stop the cloud from detecting the apparatus and the collection device.

In the embodiment of the disclosure, in an intelligent table game scene, since the first scene detection apparatus and the cloud may detect the first scene detection apparatus and the collection device respectively, a failure of a cloud device may not affect detection of the edge device and the collection device by the first scene detection apparatus. In the case of detecting that the states of the first scene detection apparatus and the collection device are normal, the scene state may further be detected according to the present scene image collected by the collection device and the locally stored related configuration file to obtain the detection result that may be used for the other business, so that an implementation situation of a scene such as the intelligent table game may be detected conveniently, normal implementation of the scene such as the intelligent table game is facilitated, and the detection flexibility and detection effect of the implementation situation of the scene such as the intelligent table game are further improved.

FIG. 12 is a structure composition diagram of a second scene detection apparatus according to an embodiment of the disclosure. As shown in FIG. 12, the second scene detection apparatus 18 includes a second detection system component 1801, a second alerting component 1802 and a second identification unit 1803.

The second detection system component 1801 is configured to pull device running data of an edge device to be detected and scene information collected by a collection device from the edge device.

The second alerting component 1802 is configured to detect a first device state of the edge device according to the device running data, and detect a second device state of the collection device according to the scene information.

The second identification component 1803 is configured to, in a case where both the first device state and the second device state are normal, detect a scene state according to a present frame of scene image in the scene information and a stored configuration file to obtain a detection result, the detection result being used for another business.

In some embodiments, the second alerting component 1802 is further configured to detect the first device state of the edge device in real time according to the device running data and a first cloud alerting rule stored in the apparatus, and detect the second device state of the collection device in real time according to the scene information and a second cloud alerting rule stored in the apparatus, the first cloud alerting rule being at least partially the same as a first local alerting rule stored in the edge device, and the second cloud alerting rule being at least partially the same as a second local alerting rule stored in the edge device.

In some embodiments, the second alerting component 1802 is further configured to, in a case where the first device state is abnormal, and/or the second device state is abnormal, send alert information to a second target device through the second alerting component, the second target device including a service device related to a scene and an Email server.

In some embodiments, the first cloud includes a service discovery component 1804 (not shown in the figure), configured to receive registration information including a device identifier of an edge device from the edge device in real time, and determine a device identifier of an edge device that stops running a first detection system component in real time. The second detection system component 1801 is further configured to obtain an updated device list based on the device identifiers through the second detection system component by adding the device identifier of the edge device that sends the registration information to a device list and deleting the device identifier of the edge device that stops running the first detection system component from the device list, and determine the edge device corresponding to the device identifier in the updated device list as the edge device to be detected.

In some embodiments, the first cloud includes a gateway component 1805 (not shown in the figure). The second detection system component 1801 is further configured to pull the device running data of the edge device to be detected and the scene information collected by the collection device from the edge device using a federation manner of the second detection system component through the gateway component.

In some embodiments, the first cloud corresponds to a first database, and the first database is associated with a log file. The first cloud further includes a storage component 1806 (not shown in the figure), configured to store the pulled device running data and scene information and the updated device list in the first database, record a storage operation on the first database in the log file, and update the log file.

In the embodiment of the disclosure, since the second scene detection apparatus detects the device states of the edge device and the collection device according to the device running data of the edge device and the scene information collected by the collection device respectively, and in a case where the states of the edge device and the collection device are normal, may detect the scene state according to the present scene image collected by the collection device and the locally stored related configuration file to obtain the detection result that may be used for the other business, so that an implementation situation of a specific scene (for example, a table game) may be detected conveniently, normal implementation of the scene is facilitated, and the detection flexibility and detection effect are further improved.

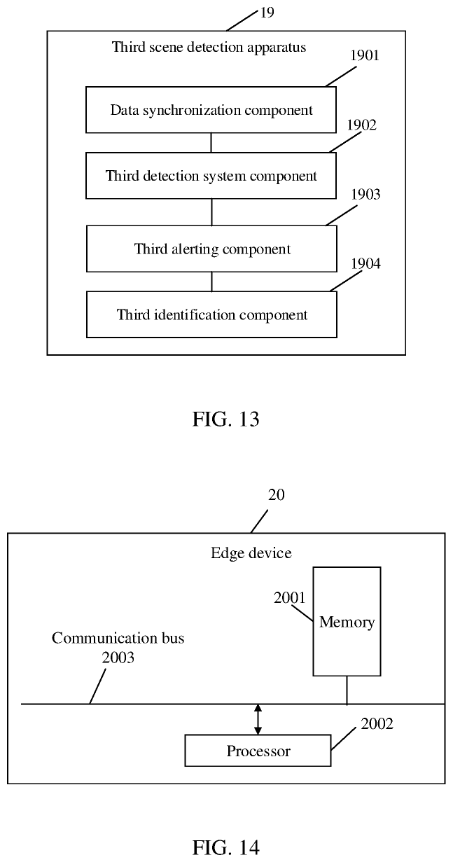

FIG. 13 is a structure composition diagram of a third scene detection apparatus according to an embodiment of the disclosure. As shown in FIG. 13, the third scene detection apparatus 19 includes a data synchronization component 1901, a third detection system component 1902, a third alerting component 1903 and a third identification unit 1904.

The data synchronization component 1901 is configured to, based on an operation recorded in a log file acquired from a first cloud, perform the same operation on a second database to make data in the second database consistent with data in a first database corresponding to the first cloud.

The third detection system component 1902 is configured to, in a case where the first cloud is abnormal, pull device running data of an edge device to be detected and scene information collected by a collection device from the edge device through the third detection system component.

The third alerting component 1903 is configured to detect a first device state of the edge device according to the device running data, and detect a second device state of the collection device according to the scene information.

The third identification component 1904 is configured to, in a case where both the first device state and the second device state are normal, detect a scene state according to a present frame of scene image in the scene information and a stored configuration file to obtain a detection result, the detection result being used for another business.

In the embodiment of the disclosure, the third scene detection apparatus may perform the same operation on the second database according to the operation recorded in the log file acquired from the first cloud to make consistent the data in the second database corresponding to the second cloud and the first database corresponding to the first cloud. When the first cloud fails, the third scene detection apparatus continues to detect the edge device and the collection device, so that influences on detection of the edge device and the collection device are eliminated. In a case where the states of the edge device and the collection device are normal, the third scene detection apparatus may further detect the scene state according to the present scene image collected by the collection device and the locally stored related configuration file to obtain the detection result that may be used for the other business, so that an implementation situation of a scene such as an intelligent table game may be detected conveniently, normal implementation of the scene is facilitated, and the detection flexibility and detection effect are further improved.

It is to be noted that “component” in the embodiments of the disclosure is “module”, and represents a software module, or a module including a software part and a hardware part, etc.

FIG. 14 is a first structure composition diagram of an electronic device according to an embodiment of the disclosure. As shown in FIG. 14, in a case where the electronic device is specifically implemented as an edge device, the edge device 20 includes a memory 2001, a processor 2002, and a computer program stored in the memory 2001 and capable of running in the processor 1902. The processor is configured to run the computer program to execute the scene detection method applied to the edge device in the abovementioned embodiments.

It can be understood that the edge device 200 further includes a bus system 2003, and each device in the edge device 20 is coupled together through the bus system 2003. It can be understood that the bus system 2003 is configured to implement connection communication between these devices. The bus system 2003 includes a data bus, and further includes a power bus, a control bus, and a state signal bus.

The memory 2001 is configured to store a computer program and application executed by the processor 2002, may also cache data (for example, image data, video data, voice communication data and video communication data) to be processed or having been processed by the processor 2002 and each module in the edge device, and may be implemented through a flash or a Random Access Memory (RAM).

The processor 2002 executes the program to implement the steps of any abovementioned scene detection method applied to the edge device. The processor 2002 usually controls overall operations of the edge device 20.

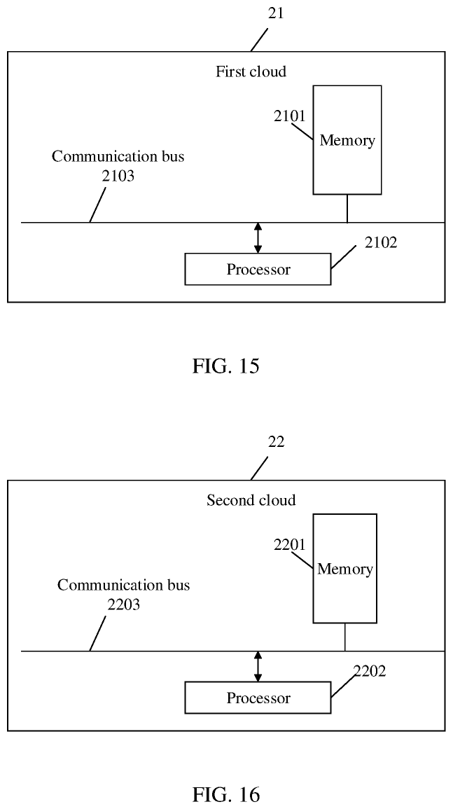

FIG. 15 is a second structure composition diagram of an electronic device according to an embodiment of the disclosure. As shown in FIG. 15, in a case where the electronic device is specifically implemented as a first cloud, the first cloud 21 includes a memory 2101, a processor 2102, and a computer program stored in the memory 2101 and capable of running in the processor 2102. The processor is configured to run the computer program to execute the scene detection method applied to the first cloud in the abovementioned embodiments.

It can be understood that the first cloud 200 further includes a bus system 2103, and each device in the first cloud 21 is coupled together through the bus system 2103. It can be understood that the bus system 2103 is configured to implement connection communication between these devices. The bus system 2103 includes a data bus, and further includes a power bus, a control bus, and a state signal bus.

The memory 2101 is configured to store a computer program and application executed by the processor 2102, may also cache data (for example, image data, video data, voice communication data and video communication data) to be processed or having been processed by the processor 2102 and each module in the first cloud, and may be implemented through a flash or a RAM.

The processor 2102 executes the program to implement the steps of any abovementioned scene detection method applied to the first cloud. The processor 2102 usually controls an overall operation of the first cloud 21.

FIG. 16 is a third structure composition diagram of an electronic device according to an embodiment of the disclosure. As shown in FIG. 16, in a case where the electronic device is specifically implemented as a second cloud, the second cloud 22 includes a memory 2201, a processor 2202, and a computer program stored in the memory 2201 and capable of running in the processor 2202. The processor is configured to run the computer program to execute the scene detection method applied to the second cloud in the abovementioned embodiments.

It can be understood that the second cloud 200 further includes a bus system 2203, and each device in the second cloud 22 is coupled together through the bus system 2203. It can be understood that the bus system 2203 is configured to implement connection communication between these devices. The bus system 2203 includes a data bus, and further includes a power bus, a control bus, and a state signal bus.

The memory 2201 is configured to store a computer program and application executed by the processor 2202, may also cache data (for example, image data, video data, voice communication data and video communication data) to be processed or having been processed by the processor 2202 and each module in the second cloud, and may be implemented through a flash or a RAM.

The processor 2202 executes the program to implement the steps of any abovementioned scene detection method applied to the second cloud. The processor 2202 usually controls an overall operation of the second cloud 22.

The processor may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a CPU, a controller, a microcontroller, or a microprocessor. It can be understood that other electronic devices may also be configured to realize functions of the processor. No limits are made in the embodiments of the disclosure.

The computer-readable storage medium/memory may be a memory such as a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disk, or a Compact Disc Read-Only Memory (CD-ROM), or may be any terminal including one or any combination of the abovementioned memories, such as a mobile phone, a computer, a tablet device, and a personal digital assistant.

The embodiments of the disclosure provide a computer program product or a computer program, which includes a computer instruction stored in a computer-readable storage medium. A processor of a computer device reads the computer instruction from the computer-readable storage medium. The processor executes the computer instruction to enable the computer device to execute the scene detection method of the embodiments of the disclosure.

In some embodiments, the executable instruction may be compiled according to a programming language of any form (including a compiling or interpretive language, or a declarative or procedural language) in form of a program, software, a software module, a script, or a code, and may be deployed according to any form, including deployed as an independent program or deployed as a module, a component, a subroutine or another unit suitable to be used in a computing environment.

As an example, the executable instruction may but not always correspond to a file in a file system, and may be stored in a part of a file that stores another program or data, for example, stored in one or more scripts in a Hyper Text Markup Language (HTML) document, stored in a single file dedicated to a discussed program, or stored in multiple collaborative files (for example, files storing one or more modules, subprograms or code parts).

As an example, the executable instruction may be deployed in a computing device for execution, or executed in multiple computing devices at the same place, or executed in multiple computing devices that are interconnected through a communication network at multiple places.

It is to be pointed out here that the above descriptions about the storage medium and device embodiments are similar to the descriptions about the method embodiment and beneficial effects similar to those of the method embodiment are achieved. Technical details undisclosed in the storage medium and device embodiments of the disclosure are understood with reference to the descriptions about the method embodiment of the disclosure.

The above is only the embodiment of the disclosure and not intended to limit the scope of protection of the disclosure. Any modifications, equivalent replacements, improvements and the like made within the spirit and scope of the disclosure fall within the scope of protection of the disclosure.

What is claimed is:

1. A scene detection method, applied to an edge device, and comprising:
acquiring device running data of the edge device and scene information collected by a collection device through a first detection system component of the edge device;
making the device running data and the scene information pulled to a cloud for the cloud to detect the edge device and the collection device;
in a case of a detection exception of the cloud, detecting a first device state of the edge device according to the device running data, and detecting a second device state of the collection device based on the scene information; and
in a case where both the first device state and the second device state are normal, detecting a scene state according to a present frame of scene image in the scene information and a locally stored configuration file to obtain a detection result, the detection result being used for another business.

2. The scene detection method of claim 1, wherein, in the case of the detection exception of the cloud, detecting the first device state of the edge device according to the device running data and detecting the second device state of the collection device based on the scene information comprises:
in the case of the detection exception of the cloud, detecting the first device state of the edge device in real time according to the device running data and a first local alerting rule stored in the edge device; and
detecting the second device state of the collection device in real time according to the scene information and a second local alerting rule stored in the edge device,
the first local alerting rule being at least partially the same as a first cloud alerting rule stored in the cloud, and the second local alerting rule being at least partially the same as a second cloud alerting rule stored in the cloud.

3. The scene detection method of claim 1, further comprising:
in a case where the first device state is abnormal, and/or the second device state is abnormal, giving an alert using an alerting part of the edge device through a first alerting component of the edge device, and/or sending alert information to a first target device through the first alerting component, the first target device being service device related to a scene.

4. The scene detection method of claim 1, wherein the situation where the first device state is normal comprises at least one of: a utilization rate of a processor is less than or equal to a preset utilization rate value, a time consumption for data processing is less than or equal to a preset time consumption threshold, or a frequency of acquiring the device running data is less than or equal to a preset frequency threshold.

5. The scene detection method of claim 1, wherein the situation where the second device state is normal comprises at least one of: the present frame of scene image exists in the scene information, or a region corresponding to the present frame of scene image is a preset collection region.

6. The scene detection method of claim 1, wherein making the device running data and the scene information pulled to the cloud for the cloud to detect the edge device and the collection device comprises:
making the device running data and the scene information pulled to the cloud using a federation manner of the first detection system component through a gateway component of the edge device for the cloud to detect the edge device and the collection device.

7. The scene detection method of claim 1, further comprising:
in a case where the first detection system component is run, sending registration information comprising a device identifier of the edge device to the cloud for the cloud to determine the edge device as an object to be detected according to the registration information.

8. The scene detection method of claim 1, further comprising:
in a case where the cloud returns to normal, making the device running data and the scene information pulled to the cloud for the cloud to detect the edge device and the collection device; or
in a case where the edge device fails, stopping making the device running data and the scene information pulled to the cloud to stop the cloud from detecting the edge device and the collection device.

9. A scene detection method, applied to a cloud, and comprising:
pulling device running data of an edge device to be detected and scene information collected by a collection device from the edge device through a second detection system component of the cloud;
detecting a first device state of the edge device according to the device running data, and detecting a second device state of the collection device according to the scene information; and
in a case where both the first device state and the second device state are normal, detecting a scene state according to a present frame of scene image in the scene information and a stored configuration file to obtain a detection result, the detection result being used for another business.

10. The scene detection method of claim 9, wherein detecting the first device state of the edge device according to the device running data and detecting the second device state of the collection device according to the scene information comprises:
detecting the first device state of the edge device in real time according to the device running data and a first cloud alerting rule stored in the cloud; and
detecting the second device state of the collection device in real time according to the scene information and a second cloud alerting rule stored in the cloud,
the first cloud alerting rule being at least partially the same as a first local alerting rule stored in the edge device, and the second cloud alerting rule being at least partially the same as a second local alerting rule stored in the edge device.

11. The scene detection method of claim 9, further comprising:
in a case where the first device state is abnormal, and/or the second device state is abnormal, sending alert information to a second target device through a second alerting component of the cloud, the second target device comprising a service device related to a scene and an Email server.

12. The scene detection method of claim 9, further comprising:
through a service discovery component of the cloud, receiving registration information comprising a device identifier of an edge device from the edge device in real time, and determining a device identifier of an edge device that stops running a first detection system component in real time; and
obtaining an updated device list based on the device identifiers through the second detection system component by adding the device identifier of the edge device that sends the registration information to a device list and deleting the device identifier of the edge device that stops running the first detection system component from the device list, and determining the edge device corresponding to the device identifier in the updated device list as the edge device to be detected.

13. The scene detection method of claim 9, wherein pulling the device running data of the edge device to be detected and the scene information collected by the collection device from the edge device through the second detection system component comprises:
pulling the device running data of the edge device to be detected and the scene information collected by the collection device from the edge device using a federation manner of the second detection system component through a gateway component of the cloud.

14. The scene detection method of claim 12, further comprising:
storing the pulling device running data and scene information, and the updated device list in a first database corresponding to the cloud; and
recording a storage operation on the first database in a log file associated with the first database, and updating the log file.

15. A scene detection method, applied to a second cloud, and comprising:
based on an operation recorded in a log file acquired from a first cloud, performing a same operation on a second database corresponding to the second cloud to make data in the second database consistent with data in a first database corresponding to the first cloud;
in a case where the first cloud is abnormal, pulling device running data of an edge device to be detected and scene information collected by a collection device from the edge device through a third detection system component of the second cloud;
detecting a first device state of the edge device according to the device running data, and detecting a second device state of the collection device according to the scene information; and
in a case where both the first device state and the second device state are normal, detecting a scene state according to a present frame of scene image in the scene information and a stored configuration file to obtain a detection result, the detection result being used for another business.
